(19) United States
(12) Patent Application Publication
(10) Pub. No.: US 2006/0248549 A1
(43) Pub. Date: Nov. 2, 2006

(54) Optical disc storage/retrieval apparatus

(76) Inventor: Chiu-Yuan Chen, Chung-Ho City (TW)

Correspondence Address: PRO-TECTOR INTERNATIONAL SERVICES, 20775 NORADA CT., SARATOGA, CA, 95070, US

(21) Appl. No.: 11/394,618

(22) Filed: Mar. 31, 2006

(30) Foreign Application Priority Data
Apr. 7, 2005 (TW) 094205353

(51) Int. Cl. G11B 17/04

(52) U.S. Cl. 720/619

(57) ABSTRACT

An optical disc storage/retrieval apparatus includes a vertically extending casing, a fixed frame mounted in the casing, an elevating platform mounted on the fixed frame and slidable in a vertical direction relative to the fixed frame, and a sliding seat mounted on the elevating platform and movable in a forward/backward direction relative to the elevating platform. The sliding seat includes a fixed lower clamping member and a movable upper clamping member pivotally mounted to the sliding seat. The casing includes an access and a plurality of vertically spaced storage compartments for storage of optical discs. A control/display device is mounted on a surface of the casing for controlling vertical movement of the elevating platform, movement of the sliding seat in the forward/backward direction, and movement of the movable upper clamping member.

### BACKGROUND OF THE INVENTION

1. Field of the Invention

The present invention relates to an optical disc storage/retrieval apparatus. More particularly, the present invention relates to a vertical type optical disc storage/retrieval apparatus.

2. Description of the Related Art

A typical optical disc storage/retrieval apparatus is of horizontal type and includes a flat, circular casing and a frame rotatably mounted in the casing. The frame includes a plurality of radially extending storage compartments each for receiving an optical disc in an upright state. Through operation of an control/display device, the frame is turned to a position near an access of the casing, allowing an optical disc to be placed onto or removed from the frame for storage or retrieval purposes.

Such a flat, circular optical disc storage/retrieval apparatus is only suitable for placing on a desk for storage/retrieval of optical discs and occupies a considerable space. More space is occupied for increased capacity of the optical disc storage/retrieval apparatus, for an increase in the size of the apparatus is inevitable.

### SUMMARY OF THE INVENTION

An objective of the present invention is to provide a vertical type optical disc storage/retrieval apparatus that stands upright on the ground or a desk to occupy a smaller space while allowing easy storage/access of optical discs.

An optical disc storage/retrieval apparatus in accordance with of the present invention comprises a vertically extending casing, a fixed frame mounted in the casing, an elevating platform mounted on the fixed frame and slidable in a vertical direction relative to the fixed frame, and a sliding seat mounted on the elevating platform and movable in a forward/backward direction relative to the elevating platform. The sliding seat includes a fixed lower clamping member and a movable upper clamping member pivotally mounted to the sliding seat. The casing includes an access and a plurality of vertically spaced storage compartments for storage of optical discs.

The optical disc storage/retrieval apparatus further comprises means for moving the elevating platform in the vertical direction, means for moving the movable upper clamping member between a holding position for holding an optical disc and a non-holding position, and means for moving the sliding seat in the forward/backward position relative to the elevating platform. The optical disc storage/retrieval apparatus further comprises a control/display device mounted on a surface of the casing. The control/display device is operable to control vertical movement of the elevating platform, movement of the sliding seat in the forward/backward direction, and movement of the movable upper clamping member.

Preferably, the casing comprises a vertically extending front casing and a vertically extending rear casing fixedly coupled together. The front casing includes an upper wall and a lower wall. A front panel is coupled with the upper wall and the lower wall. The control/display device is mounted on a top of the front panel. The rear casing includes two sidewalls for enclosing the upper wall and the lower wall of the front casing.

Preferably, the optical disc storage/retrieval apparatus further comprises a row of vertically spaced indicator lights for indicating a level of the elevating platform.

Preferably, the optical disc storage/retrieval apparatus further comprises a stop rod pivotally mounted in the casing and means for pivotally moving the stop rod in a first position blocking the access and a second position not blocking the access.

Preferably, the means for moving the stop rod comprises an arcuate rack extending from an intermediate portion of the stop rod, a gear train meshed with the arcuate rack, and a motor for driving the gear train.

Preferably, the means for moving the elevating platform includes a vertical rack, a gear train meshed with the vertical rack, and a motor for driving the gear train to turn.

Preferably, the means for moving the sliding seat in the forward/backward direction includes a screw rod, a gear train meshed with the screw rod, and a motor for driving the gear train to turn.

Preferably, the optical disc storage/retrieval apparatus further comprises a locking board and means for moving the locking board between a first position closing the storage compartments and a second position revealing the storage compartments.

Preferably, the means for moving the locking board comprises a vertical drive board adjacent to the locking board. The drive board includes a plurality of vertically spaced longitudinal holes and a plurality of vertically spaced drive pins. The locking board includes a plurality of transverse holes and a plurality of slant slots. Each drive pin extends through an associated one of the slant slots. Screws are provided and each extends through an associated one of the longitudinal holes and an associated one of the transverse holes for coupling with the casing. A rack is mounted to the drive board, and a motor drives the rack to move the drive board vertically, which in turn causes transverse movement of the locking board between the first position and the second position.

Preferably, the fixed frame includes an upper member, a lower member, and a plurality of vertical guiding posts. A roller is provided on each side of each of the upper member and the lower member. A vertical track is provided between the upper member and the lower member. A weight member is slidably mounted on the vertical track. A cable is wound around the rollers and includes a first end attached to the weight member and a second end connected to the elevating platform.

Preferably, the optical disc storage/retrieval apparatus further comprises a torque limiter and a sleeve for cooperating with the screw rod. An actuating plate is mounted on the sleeve. A front photoelectric switch, a middle photoelectric switch, and a rear photoelectric switch are mounted on the elevating platform in a travel of the actuating plate of the sliding seat. The fixed frame and the elevating platform further comprise two actuating members and two photoelectric switches for limiting vertical travel of the elevating platform.

Preferably, the optical disc storage/retrieval apparatus further comprises a guiding block mounted on the sliding seat, and the elevating platform further comprises a track for guiding the guiding block on the sliding seat.

Preferably, the movable upper clamping member includes a front clamping plate and an arcuate rack. A clamping space is defined between the front clamping plate and the fixed lower clamping member. The means for moving the movable upper clamping member includes a gear train meshed with the arcuate rack and a motor for driving the gear train, thereby moving the movable upper clamping member between the holding position and the non-holding position.

Preferably, the optical disc storage/retrieval apparatus further comprises a photoelectric switch mounted on the sliding seat and a detecting lever. The detecting lever includes a front, horizontal section, an intermediate portion pivotally connected to the sliding seat, and a rear, vertical section. The front, horizontal section includes a front end normally biased to a position between the front clamping plate and the fixed lower clamping member. The rear, vertical section includes an actuating plate extending upward through the sliding seat for cooperating with the photoelectric switch.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a vertical type optical disc storage/retrieval apparatus in accordance with the present invention.

FIG. 2 is a sectional view of an upper portion of the optical disc storage/retrieval apparatus in accordance with the present invention.

FIG. 3 is an exploded perspective view illustrating a front casing and a front panel of the optical disc storage/retrieval apparatus in accordance with the present invention.

FIG. 4 is a perspective view of a fixed frame and an elevating platform of the optical disc storage/retrieval apparatus in accordance with the present invention.

FIG. 5 is a perspective view illustrating the elevating platform and a sliding seat in FIG. 4.

FIG. 6 is an exploded perspective view of the sliding seat in FIG. 5.

FIG. 7 is a view illustrating storage compartments and a locking device in FIG. 2.

FIG. 8 is a sectional view taken along plane 8-8 in FIG. 7.

FIG. 9 is an exploded perspective view of the locking device and indicator lights in FIG. 7.

FIG. 10 is a view similar to FIG. 7, illustrating locking operation.

FIG. 11 is a sectional view taken along plane 11-11 in FIG. 10.

FIG. 12 is a view similar to FIG. 2, wherein an optical disc is clamped in the sliding seat and moved backward to a predetermined position.

FIG. 13 is a view similar to FIG. 12, wherein an optical disc is being stored or retrieved.

### DETAILED DESCRIPTION OF THE PREFERRED EMBODIMENT

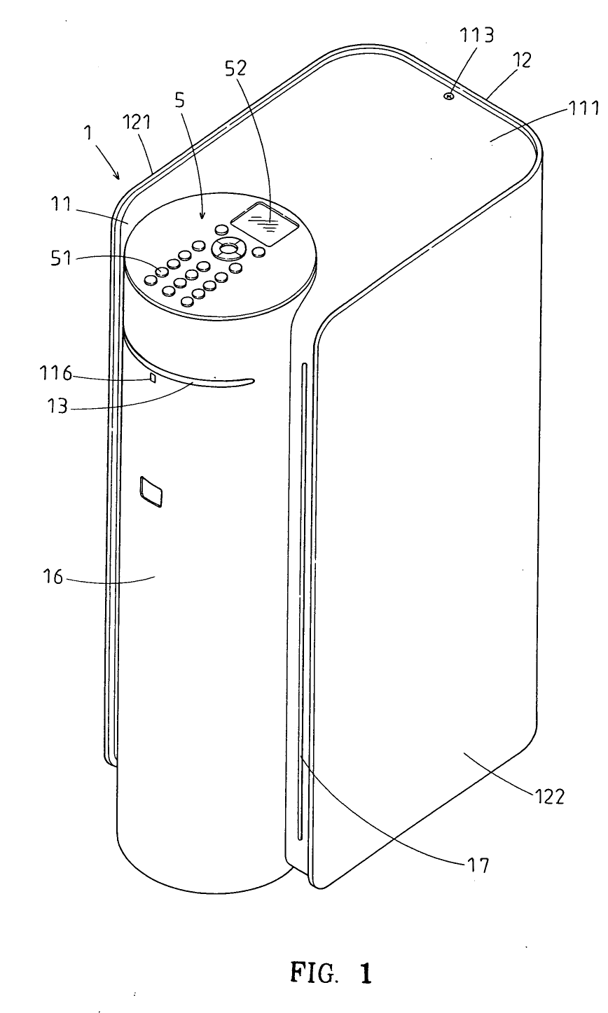

Referring to FIGS. 1 through 5, a vertical type optical disc storage/retrieval apparatus in accordance with the present invention comprises a vertical casing 1 in which a fixed frame 2, an elevating platform 3, and a sliding seat 4 are mounted. The apparatus further includes a control/display device 5 to control the elevating platform 3 to move vertically along the fixed frame 2, to control the sliding seat 4 to move forward/backward along the fixed frame 2, and to control a movable upper clamping member 42 on the sliding seat 4 to hold or release an optical disc 9.

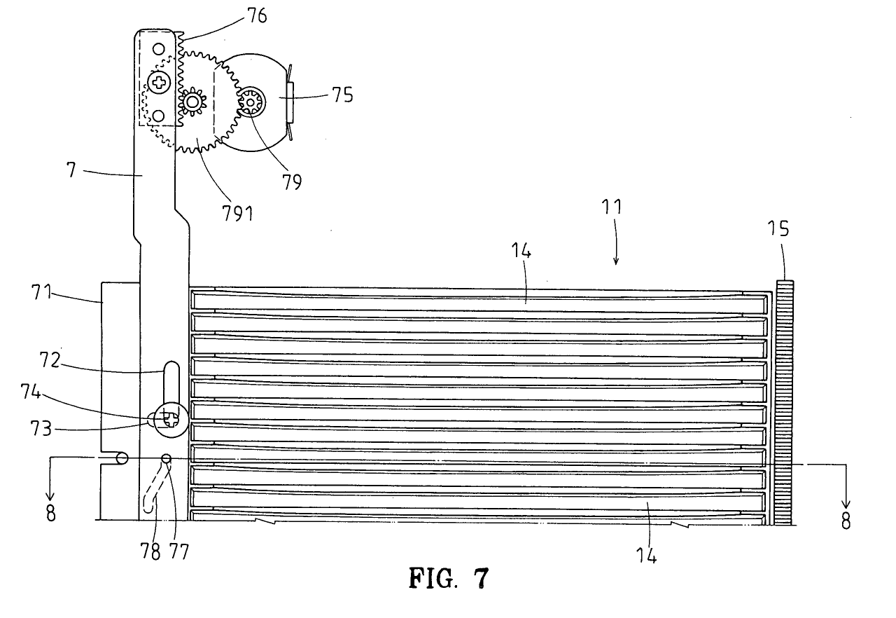

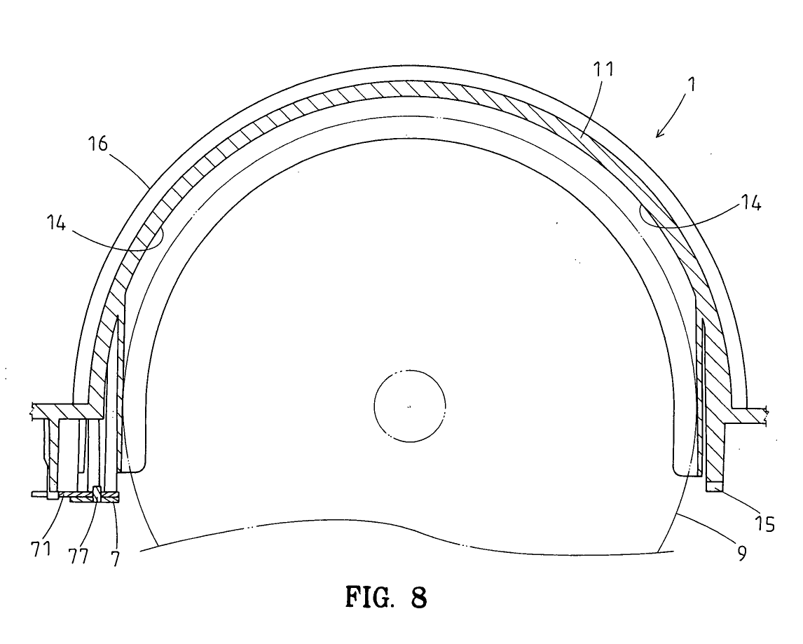

Referring to FIGS. 1 through 3, the casing 1 includes a front casing 11 and a rear casing 12 fixedly coupled to the front casing 11 by bolts 113 in an upright manner. The front casing 11 includes an access 13 in an upper portion thereof, allowing an optical disc to be inserted into or moved out of the casing 1. Behind and below the access 13 is an optical disc storage section having a plurality of vertically spaced storage compartments 14. A vertical rack 15 (see FIGS. 7 and 8) is located adjacent to the optical disc storage section.

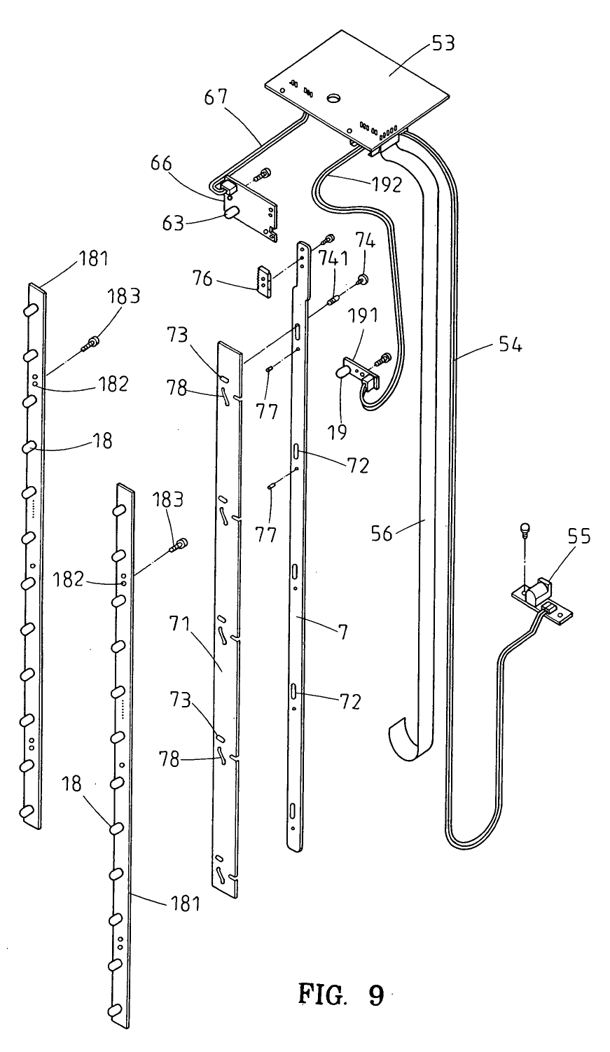

In the preferred embodiment, the front casing 11 includes an upper wall 111 and a lower wall 112 for coupling with a front panel 16. The control/display device 5 is mounted on a top face of the front panel 16. The rear casing 12 includes two sidewalls 121 and 122 for enclosing the upper and lower walls 111 and 112. Each of two sides of the front casing 11 includes a vertical light-guiding strip 17 and a row of indicator lights 18 behind the vertical light-guiding strip 17 (see FIG. 9). The indicator lights 18 are mounted on a circuit board 181 having through-holes 182. Screws 183 are extended through the through-holes 182 to fix the circuit boards 181 to the front casing 1. The indicator lights 18 are turned on and off in response to vertical movement of the elevating platform 3 to indicate the level of the elevating platform 3.

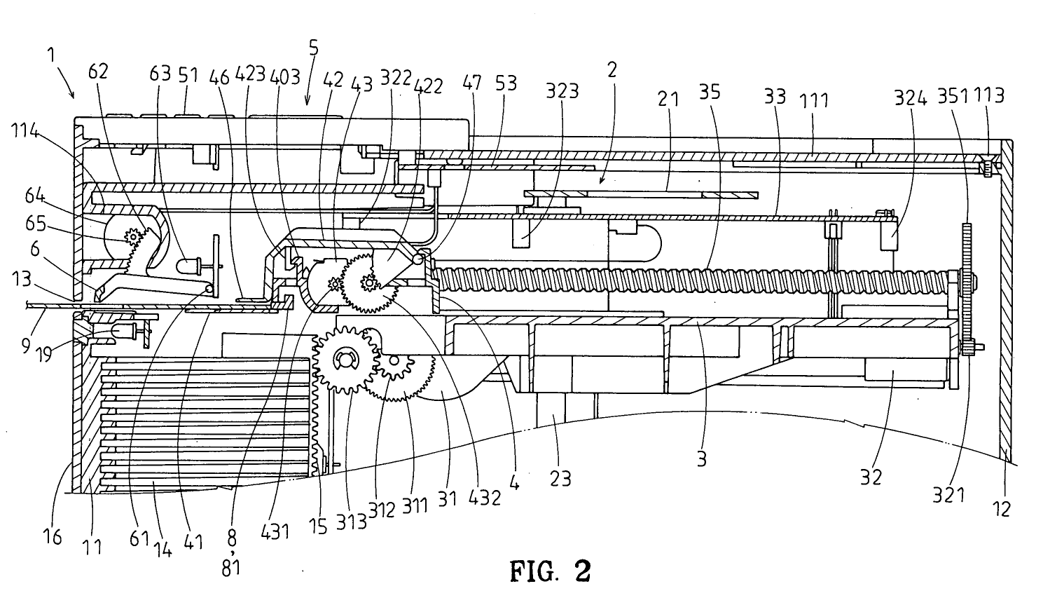

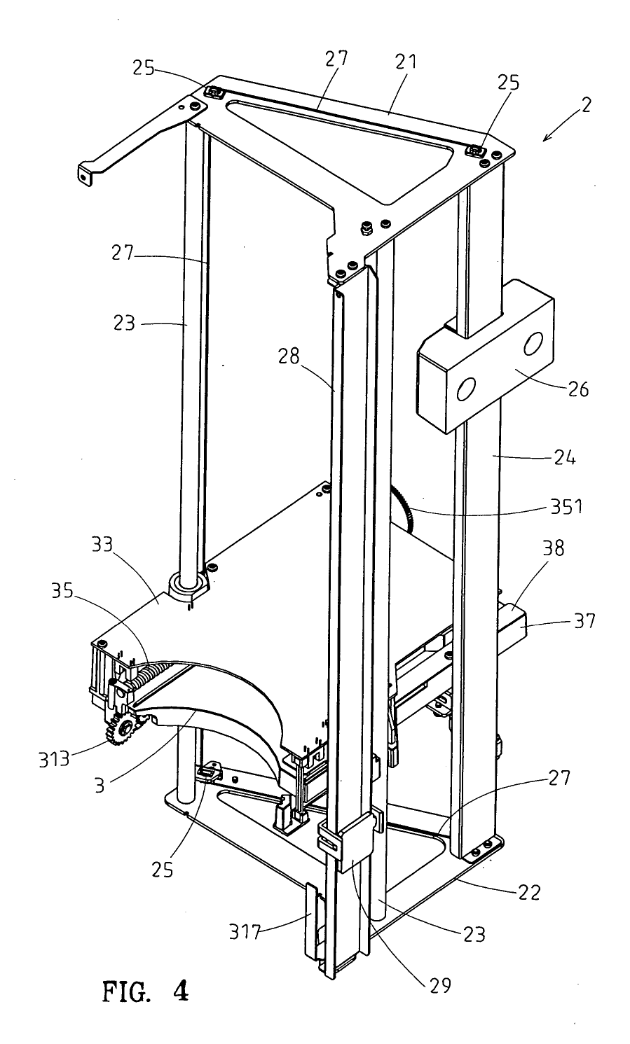

Referring to FIGS. 2 and 4, the fixed frame 2 includes an upper member 21, a lower member 22, and a plurality of guiding posts 23 fixed between the upper and lower members 21 and 22. The fixed frame 2 is fixed in the casing 1 in an upright state. A roller 25 is provided on each side of each of the upper and lower members 21 and 22, and a vertical track 24 is provided between the upper and lower members 21 and 22. A weight member 26 is slidably mounted on the vertical track 24. A cable 27 is wound around the rollers 25 and has an end connected to the weight member 26. The other end of the cable 27 is fixed to the elevating platform 3. The weight of the elevating platform 3 is thus balanced by the weight member 26. A wire track 28 and a slider 29 can be provided to guide a cord 56 extending from a control panel 53 (see FIG. 9).

Referring to FIGS. 2, 4, and 5, the elevating platform 3 is slidably mounted on the guiding posts 23 of the fixed frame 2. A first motor 31 (e.g., a step motor) is mounted to a front end of the elevating platform 3 and includes an output shaft (not labeled) on which a gear 312 is mounted. The gear 311 meshes with a gear 312, which in turn meshes with another gear 313 that meshes with the vertical rack 15. A longitudinal screw rod 35 is rotatably supported at a top of the elevating platform 3 by a seat 304. A gear 351 is mounted to an end of the screw rod 35 and meshes with a gear 321 on an output shaft (not labeled) of a second motor 32. A guiding barrel 301 is mounted to a sidewall 34 of the elevating platform 3 and a sleeve 303 is mounted in the guiding barrel 301. A guiding opening 302 is defined in the other sidewall (not labeled) of the elevating platform 3. A post 23 extends through the guiding barrel 301 and another post 23 extends through the guiding opening 302. Thus, the elevating platform 3 is movably mounted around the posts 23 respectively on two sides of the fixed frame 2. A drive board 33 is mounted on top of the elevating platform 3 and a photoelectric sensor 36 is mounted to a front end of the other sidewall of the elevating platform 3 for detecting whether an optical disc 9 is stored in each storage compartment 14.

Referring to FIGS. 2, 5, and 6, the sliding seat 4 is mounted on the elevating platform 3 in the longitudinal direction. The screw rod 35 is rotatably extended through a side of the sliding seat 4. A fixed lower clamping member 41 extends forward from the sliding seat 4. A movable upper clamping member 42 is pivotally mounted to the sliding seat 4 and driving means is provided for controlling the movable upper clamping member 42 for holding or releasing an optical disc 9.

In the preferred embodiment, a torque limiter 44 and a sleeve 45 are mounted to a side of the sliding seat 4 and cooperate with the screw rod 35. A shaft sleeve 451 is mounted in sleeve 45 and an actuating plate 452 is mounted to an upper side of the sleeve 45. The torque limiter 44 is made of steel and includes a through-hole 441 in an end thereof. A screw 443 is extended through the through-hole 441 to secure the torque limiter 44 to the sliding seat 4. A socket 442 is formed in the other end of the torque limiter 44 and a ball 444 is received in the socket 442 for mating with the threads of the screw rod 35. A guiding block 48 is provided on the other side of the sliding seat 4. A front photoelectric switch 322, a middle photoelectric switch 323, and a rear photoelectric switch 324 are respectively mounted to a front end, a middle portion, and a rear end of the drive board 33 of the elevating platform 3 in the travel of the actuating plate 452 of the sliding seat 4. A track 37 is provided on the elevating platform 3 for guiding the guiding block 48 on the sliding seat 4. Two photoelectric switches 314 and 315 and their respective actuating members 3,16 and 317 are respectively provided on the elevating platform 3 and the fixed frame 2 for controlling upper and lower travel limits of the elevating platform 3.

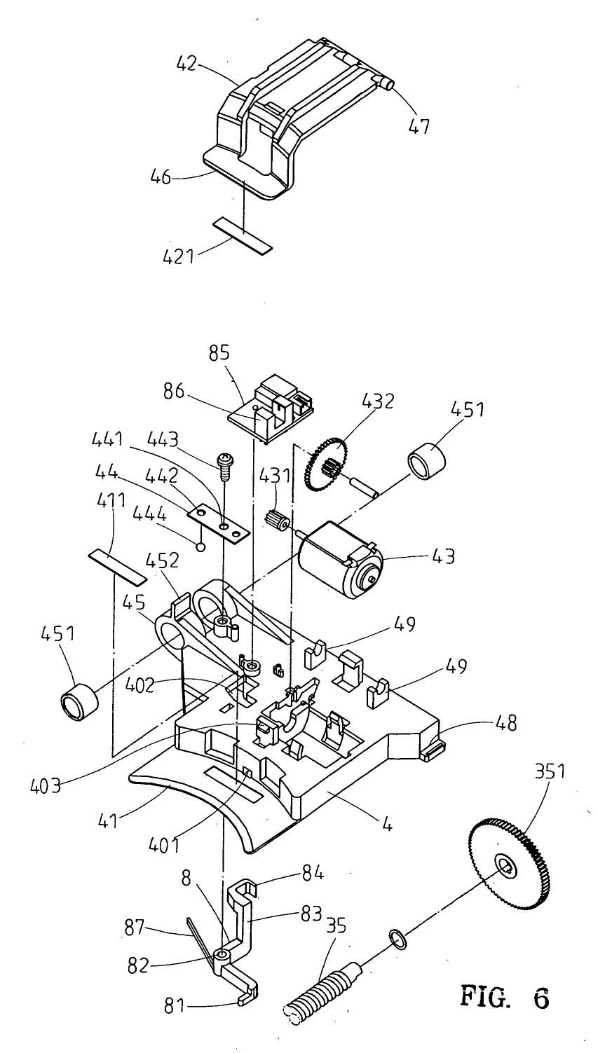

The movable upper clamping member 42 of the sliding seat 4 includes a front clamping plate 46, a supporting rod 47 pivoted to a pair of seats 49 on a rear end of the sliding seat 4, and an arcuate rack 422 located in a bottom of the rear end of the sliding seat 4. The front clamping plate 46 and the fixed lower clamping member 41 define a clamping space, and pads 411 and 421 are provided on the front clamping plate 46 and the lower clamping member 41 (see FIG. 6). The driving means includes a third motor 43 mounted in a top of the sliding seat 4. A gear 431 is mounted on an output shaft (not labeled) of the third motor 43. Reduction gears 432 are provided between the gear 431 and the arcuate rack 422. Thus, the movable upper clamping member 42 can pivot between an open position and a closing position through operation of the drive device. Further, the sliding seat 4 and the movable upper clamping member 42 respectively include stop hooks 403 and 423 for limiting travel of the movable upper clamping member 42.

A detecting lever 8 is pivotally mounted in a bottom of the sliding seat 4 for detecting whether an optical disc is inserted (see FIGS. 2, 5, and 6). Further, a photoelectric switch 85 and a circuit board 86 are mounted on top of the sliding seat 4. The detecting lever 8 includes a front, horizontal section 81, a pivotal hole 82 that is defined in an intermediate portion for pivotal connection with the sliding seat 4, and a rear, vertical section 83. A front end of the front, horizontal section 81 is biased outward by a resilient arm 87 to extend through a front through-hole 401 of the sliding seat 4 into a position between the front clamping plate 46 and the fixed lower clamping member 41. The rear, vertical section 83 includes an actuating plate 84 extending upward through a top through-hole 402 in the sliding seat 4 for cooperating with the photoelectric switch 85.

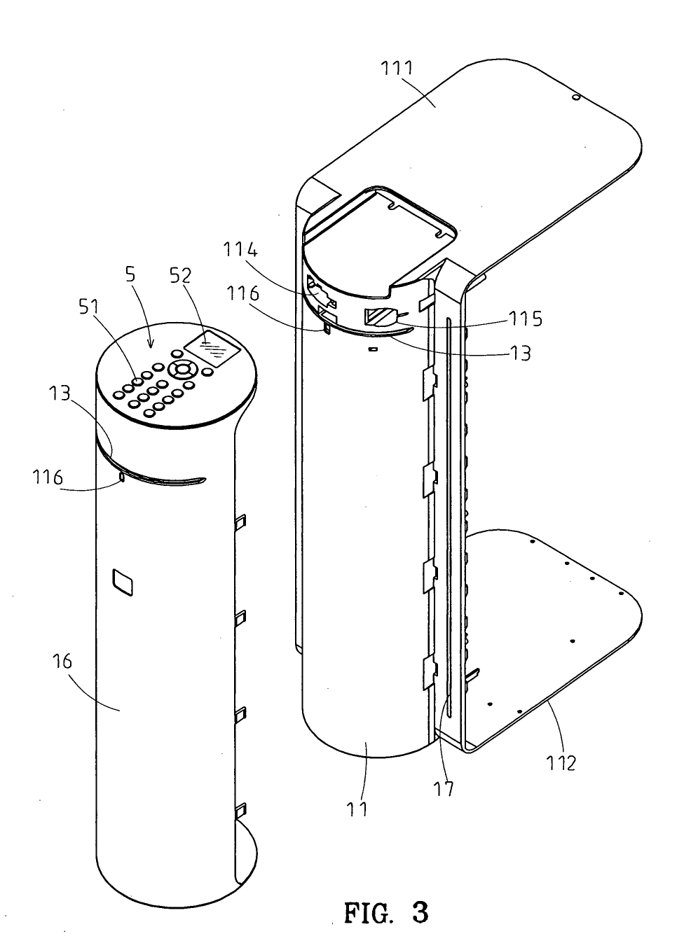

In the preferred embodiment shown in FIGS. 2 and 3, the front casing 11 includes a stop rod 6 in association with the access 13. A supporting rod 62 is mounted to a rear end of the stop rod 6 and acts as a fulcrum. An arcuate rack 62 is fixed to an intermediate portion of the stop rod 6. A fourth motor 64 is fixed in a recess 114 in the front casing 11. A gear 65 is mounted on an output shaft (not labeled) of the fourth motor 64 and meshes with the arcuate rack 62.

Referring to FIGS. 1, 2, and 3, the control/display device 5 is mounted on a front, top portion of the casing 1 and includes a keyboard 51, a liquid crystal display 52, and an internal control circuit board 53 (see FIG. 9). The control/display device 5 allows a user to select one of the storage compartments 14 for storage or retrieval of an optical disc 9. An end of a power line 54 for the control/display device 5 is electrically connected to a socket 55 for external power connection. The control circuit board 53 is electrically connected to the drive board 33 of the elevating platform 3. A wire 192 is electrically connected to a circuit board 191. A power light 19 is mounted on the circuit board 191 and received on a light-receiving hole 116 in the front casing 11. Another wire 67 is electrically connected to a circuit board 66 on which an operation indicating light 63 is mounted. Storage/retrieval of optical discs can thus be controlled electronically.

When storage of an optical disc 9 is required, the user operates the control/display device 5 to select a storage compartment 14 in which the optical disc 9 is to be stored. The screw rod 35 is turned by the second motor 32 through transmission by the gears 321 and 351, thereby moving the sliding seat 4 backward to its rear position through control of the torque limiter 44. Next, the first motor 31 is turned on, causing the gears 311, 312 and 313 to turn. Since the gear 313 meshes with the vertical rack 15, the elevating platform 3 moves upward to its uppermost position shown in FIG. 2. Next, the second motor 32 is turned on, moving the sliding seat 4 forward to its front position (left position in FIG. 2). Next, the third motor 43 is turned on to drive the gears 431 and 432. Since the gear 432 meshes with the arcuate rack 422, the movable upper clamping member 42 (and the front clamping plate 46 on the movable upper clamping member 42) pivots upward, thereby opening the clamping space.

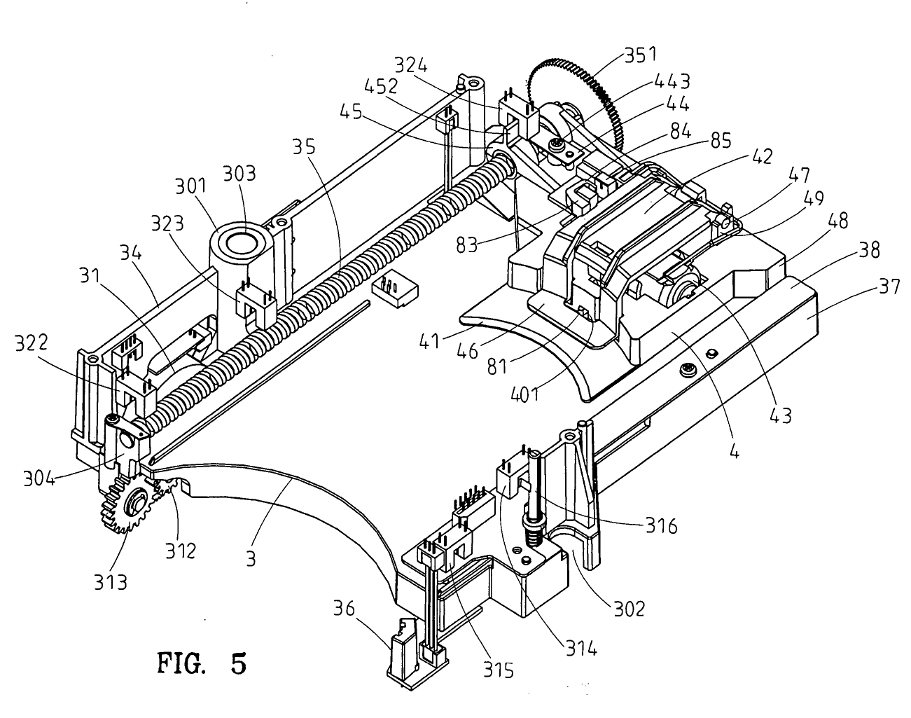

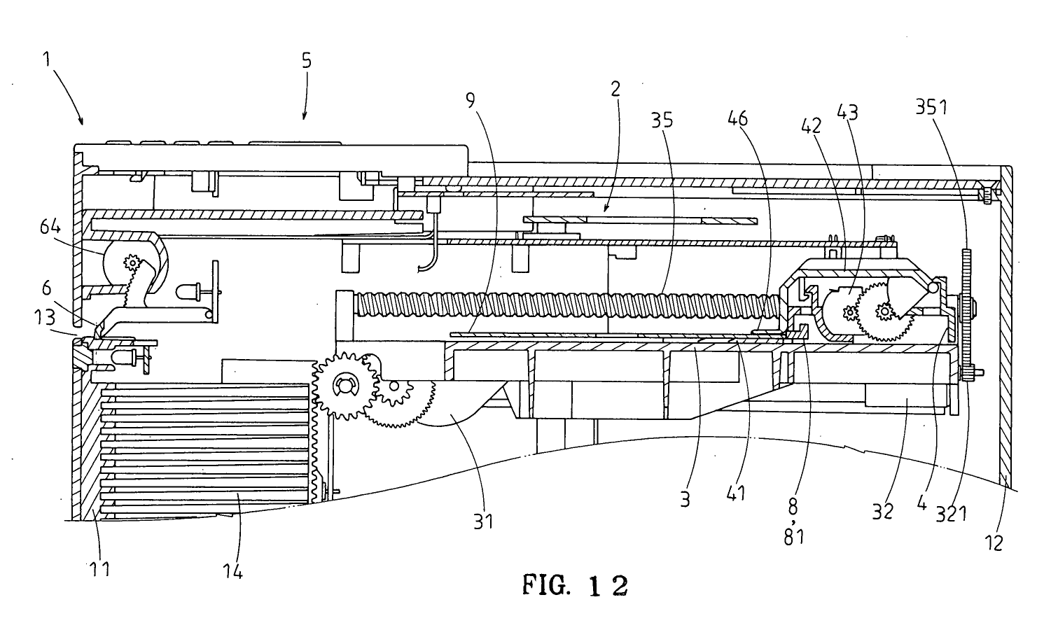

Then, the fourth motor 64 is turned on to drive the gear 65 to turn. Since the gear 65 meshes with the arcuate rack 62, the stop rod 6 pivots upward, allowing an optical disc 9 to be inserted into the clamping space between the sliding seat 4 and the movable upper clamping member 42. When the optical disc 9 is in place, the front end of the front, horizontal section 81 of the detecting lever 8 is pushed (see FIGS. 5, 6, and 12), causing the actuating plate 84 on the rear, vertical section 83 to pivot away from the photoelectric switch 85. Then third motor 43 is turned on again, turning the gear 431 and the gear 432 that meshes with the arcuate rack 422. The movable upper clamping member 42 and the front clamping plate 46 pivot downward to hold the optical disc 9. The second motor 32 is then turned on again, moving the sliding seat 4 backward to its rear position (right position in FIG. 12). At this time, the stop rod 6 pivots downward to block the access 13 through operation of the fourth motor 64, preventing insertion of another optical disc 9.

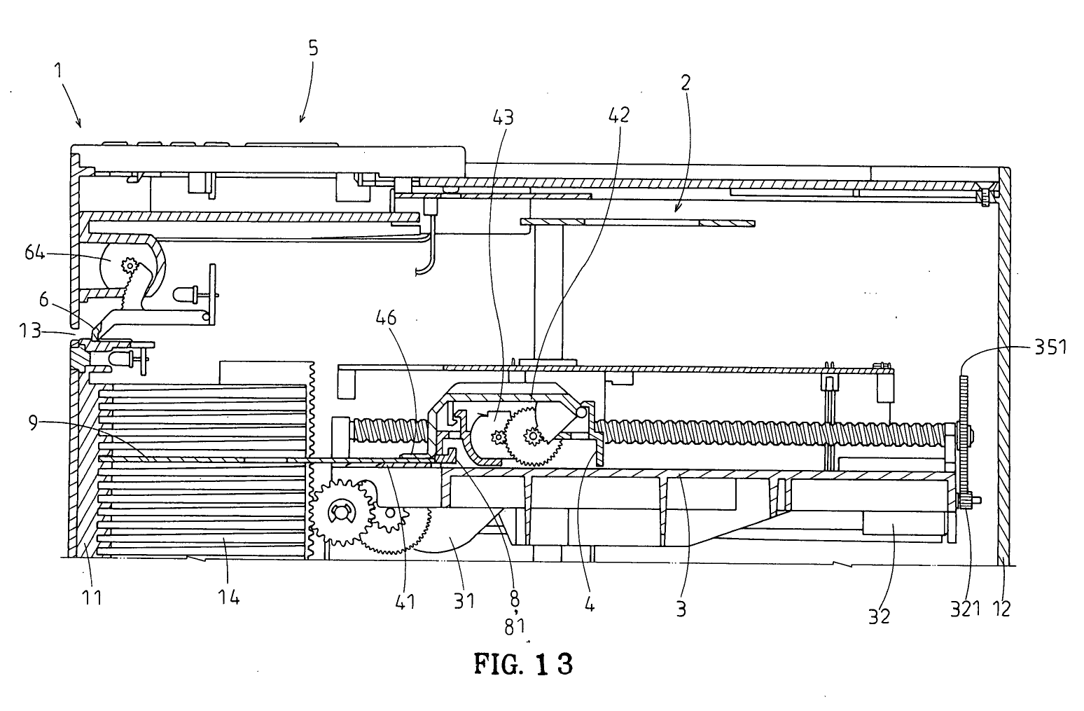

Then, through operation of the first motor 31, the elevating platform 31 is moved downward to a level where the selected storage compartment 14 locates. The sliding seat 4 is then moved forward to a position shown in FIG. 13 through operation of the second motor 32, and the optical disc 9 is inserted into the selected storage compartment 14. At this time, the elevating platform 13 may be slightly moved downward, and the movable upper clamping member 42 is moved upward through operation of the third motor 43, leaving the optical disc 9 in the selected storage compartment 14. Next, the second motor 32 moves the sliding seat 4 backward to its rear position, and the first motor 31 moves the elevating platform 3 upward to its uppermost position. Then, the sliding seat 4 is moved forward to its front position shown in FIG. 2 for receiving another optical disc 9.

When retrieval of optical disc 9 is desired, the user operates the control/display device 5 to select the storage compartment 14 in which the optical disc 9 to be retrieved is received. The second motor 32 moves the sliding seat 4 backward to its rear position, and the first motor 31 moves the elevating platform 3 downward to the level where the selected storage compartment 14 locates. The sliding seat 4 is then moved forward to a position shown in FIG. 13. The third motor 43 moves the movable upper clamping member 42 downward to hold the optical disc 9 in the selected storage compartment 14. Next, the sliding seat 4 is moved backward to its rear position, and the elevating platform 3 is moved upward to a position shown in FIG. 12. Then, the sliding seat 4 is moved to its front position, and the optical disc 9 is moved out of the casing 1 through the access 13. Then, the third motor 43 moves the movable upper clamping member 42, allowing the user to remove the optical disc 9.

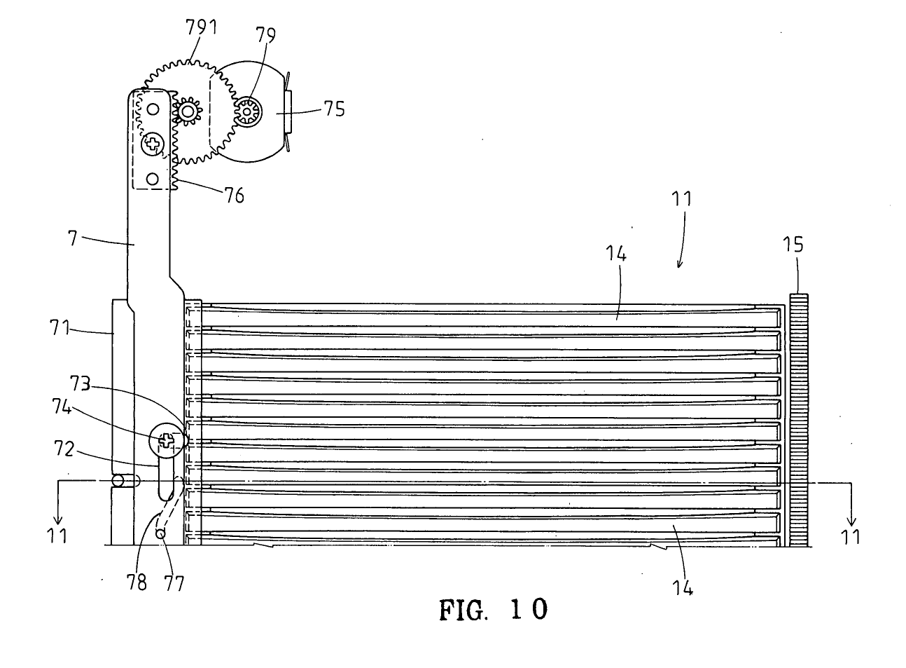

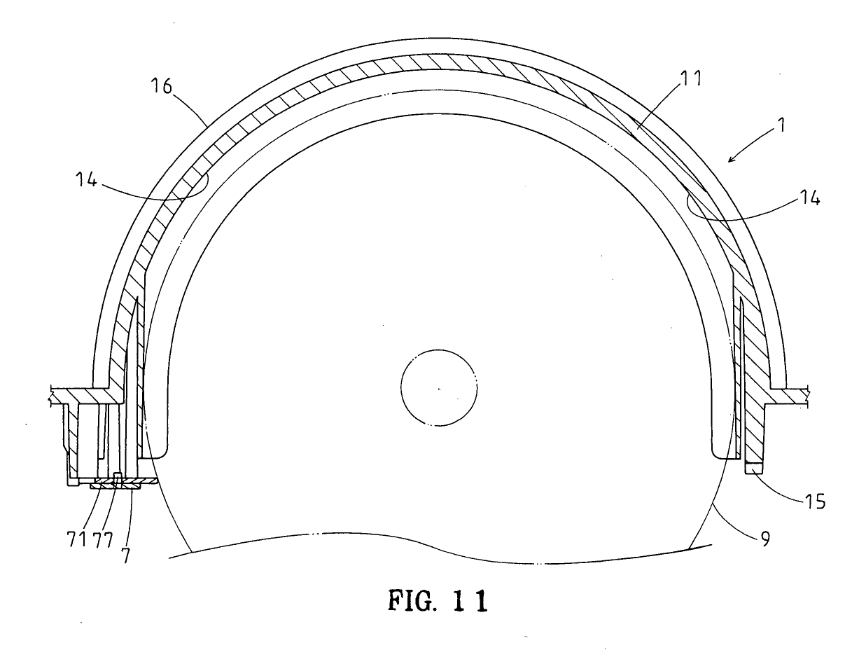

In the preferred embodiment shown in FIGS. 7 through 11, a vertical drive board 7 is mounted in the casing 11 and adjacent to the storage section where the optical discs are stored. A locking board 71 is mounted adjacent to the drive board 7. The drive board 7 includes a plurality of vertically spaced longitudinal holes 72 and a plurality of vertically spaced drive pins 77. A rack 76 is fixed to an upper end of the drive board 7. The locking board 71 includes a plurality of transverse holes 72 in association with the longitudinal holes 72. The locking board 71 further includes a plurality of slant slots 78 in association with the drive pins 77. A corresponding number of screws 74 are respectively coupled with a corresponding number of screw rods 741. Each screw rod 741 is extended through an associated longitudinal hole 72 in the drive board 7 and an associated transverse hole 73 in the locking board 71 for coupling with the front casing 1. A fifth motor 75 is fixed in a recess 115 in the front casing 11 (see FIG. 3). A gear 79 is mounted on an output shaft (not labeled) of the fifth motor 75 and meshes with a gear train 791, which in turn meshes with the rack 76. Thus, the fifth motor 75 can be operated to move the drive board 7 in the vertical direction. The drive pins 77 move in the respective slant slots 78 to move the locking board 71 in a transverse direction for opening/locking the storage compartments 14. When the optical disc storage/retrieval apparatus is not in use or to be transported, the locking board 71 can be moved to close the storage compartments 14 (see FIG. 11), avoiding the optical discs 9 from falling out of the storage compartments 14.

The vertical optical disc storage/retrieval apparatus in accordance with the present invention may stand upright on the ground or desk and occupies a smaller space while allowing easy storage/retrieval of optical discs.

Although specific embodiments have been illustrated and described, numerous modifications and variations are still possible without departing from the essence of the invention. The scope of the invention is limited by the accompanying claims.

What is claimed is:

1. An optical disc storage/retrieval apparatus comprising:
a vertically extending casing including an access, the casing further including a plurality of vertically spaced storage compartments for storage of optical discs;
a fixed frame mounted in the casing;
an elevating platform mounted on the fixed frame and slidable in a vertical direction relative to the fixed frame;
means for moving the elevating platform in the vertical direction;
a sliding seat mounted on the elevating platform and movable in a forward/backward direction relative to the elevating platform, the sliding seat including a fixed lower clamping member, a movable upper clamping member being pivotally mounted to the sliding seat;
means for moving the movable upper clamping member between a holding position for holding an optical disc and a non-holding position;
means for moving the sliding seat in the forward/backward position relative to the elevating platform; and
a control/display device mounted on a surface of the casing, the control/display device being operable to control vertical movement of the elevating platform, movement of the sliding seat in the forward/backward direction, and movement of the movable upper clamping member.

2. The optical disc storage/retrieval apparatus as claimed in claim 1 wherein the casing comprising a vertically extending front casing and a vertically extending rear casing fixedly coupled together, the front casing including an upper wall and a lower wall, a front panel being coupled with the upper wall and the lower wall, the control/display device being mounted on a top of the front panel, the rear casing including two sidewalls for enclosing the upper wall and the lower wall of the front casing.

3. The optical disc storage/retrieval apparatus as claimed in claim 1 further comprising a row of vertically spaced indicator lights for indicating a level of the elevating platform.

4. The optical disc storage/retrieval apparatus as claimed in claim 1 further comprising a stop rod pivotally mounted in the casing and means for pivotally moving the stop rod in a first position blocking the access and a second position not blocking the access.

5. The optical disc storage/retrieval apparatus as claimed in claim 4 wherein said means for moving the stop rod comprising an arcuate rack extending from an intermediate portion of the stop rod, a gear train meshed with the arcuate rack, and a motor for driving the gear train.

6. The optical disc storage/retrieval apparatus as claimed in claim 1 wherein said means for moving the elevating platform includes a vertical rack, a gear train meshed with the vertical rack, and a motor for driving the gear train to turn.

7. The optical disc storage/retrieval apparatus as claimed in claim 1 wherein said means for moving the sliding seat in the forward/backward direction includes a screw rod, a gear train meshed with the screw rod, and a motor for driving the gear train to turn.

8. The optical disc storage/retrieval apparatus as claimed in claim 1 further comprising a locking board and means for moving the locking board between a first position closing the storage compartments and a second position revealing the storage compartments.

9. The optical disc storage/retrieval apparatus as claimed in claim 1 wherein said means for moving the locking board comprises a vertical drive board adjacent to the locking board, the drive board including a plurality of vertically spaced longitudinal holes and a plurality of vertically spaced drive pins, the locking board including a plurality of transverse holes and a plurality of slant slots, each said drive pin extending through an associated one of the slant slots, further comprising a plurality of screws each extending through an associated one of the longitudinal holes and an associated one of the transverse holes and coupled with the casing, a rack being mounted to the drive board, and a motor for driving the rack to move the drive board vertically, which in turn causes transverse movement of the locking board between the first position and the second position.

10. The optical disc storage/retrieval apparatus as claimed in claim 1 wherein the fixed frame includes an upper member, a lower member, and a plurality of vertical guiding posts, a roller being provided on each side of each of the upper member and the lower member, a vertical track being provided between the upper member and the lower member, a weight member being slidably mounted on the vertical track, a cable being wound around the rollers and including a first end attached to the weight member and a second end connected to the elevating platform.

11. The optical disc storage/retrieval apparatus as claimed in claim 7 further comprising a torque limiter and a sleeve for cooperating with the screw rod, an actuating plate being mounted on the sleeve, a front photoelectric switch, a middle photoelectric switch, and a rear photoelectric switch being mounted on the elevating platform in a travel of the actuating plate of the sliding seat, the fixed frame and the elevating platform further comprising two actuating members and two photoelectric switches for limiting vertical travel of the elevating platform.

12. The optical disc storage/retrieval apparatus as claimed in claim 11 further comprising a guiding block mounted on the sliding seat, and the elevating platform further comprising a track for guiding the guiding block on the sliding seat.

13. The optical disc storage/retrieval apparatus as claimed in claim 1 wherein the movable upper clamping member includes a front clamping plate and an arcuate rack, a clamping space being defined between the front clamping plate and the fixed lower clamping member, said means for moving the movable upper clamping member including a gear train meshed with the arcuate rack and a motor for driving the gear train, thereby moving the movable upper clamping member between the holding position and the non-holding position.

14. The optical disc storage/retrieval apparatus as claimed in claim 13 further comprising a photoelectric switch mounted on the sliding seat and a detecting lever, the detecting lever including a front, horizontal section, an intermediate portion pivotally connected to the sliding seat, and a rear, vertical section, the front, horizontal section including a front end normally biased to a position between the front clamping plate and the fixed lower clamping member, the rear, vertical section including an actuating plate extending upward through the sliding seat for cooperating with the photoelectric switch.
